(19) United States
(12) Patent Application Publication
(10) Pub. No.: US 2010/0055419 A1
(43) Pub. Date: Mar. 4, 2010

(54) HOUSING AND MANUFACTURING METHOD THEREOF

(75) Inventors: FEI WU, Shenzhen City (CN); XIAN-LIANG LIU, Shenzhen City (CN); HONG-BING ZHANG, Shenzhen City (CN); CHAO-HSUN LIN, Taipei (TW); JEN-LUNG HUANG, Taipei (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/486,018

(22) Filed: Jun. 17, 2009

(30) Foreign Application Priority Data
Aug. 27, 2008 (CN) 200810304215.7

(51) Int. Cl. B32B 3/10; C23F 1/00

(52) U.S. Cl. 428/206; 216/39

(57) ABSTRACT

A housing with a three dimensional pattern coating includes a substrate, a powder coated layer formed on the substrate, the powder coated layer having plural grooves therein; and a pattern coating formed in the grooves. A method for making the housing comprises: providing a substrate; painting a powder coated layer onto the substrate; etching the powder coated layer to form plural grooves; filling the grooves with a colloidal solution.

### BACKGROUND

1. Technical Field

The present disclosure relates to housings, especially to a housing having a three dimensional pattern coating and a manufacturing method thereof.

2. Description of Related Art

Portable electronic devices commonly employ a variety of decorative housings to attract consumers. Some of the housings are made of metal. These metal housings may be coated with paint or ink to provide a decorative appearance. Typically, paint can be applied to the surface of the metal housings by oil paint spray or electrostatic powder coating. In a powder coating paint operation, the powder paint is at a high rate of paint recovery, and the whole process is environmentally friendly due to the non-volatilizing of the powder paint. So, the powder paint is widely used to form coatings onto the surfaces of the housings.

A logo or a symbolical pattern is usually formed on the surface of the coatings by printing. The logo or symbolical pattern can not present three dimensional appearance because of its thin thickness. In addition, the logo or symbolical pattern formed by printing has poor adhesion to the coatings, and is prone to be abraded.

Therefore, there is room for improvement within the art.

### BRIEF DESCRIPTION OF THE DRAWINGS

Many aspects of the housing with a three dimensional pattern coating can be better understood with reference to the following drawings. The components in the drawings are not necessarily drawn to scale, the emphasis instead being placed upon clearly illustrating the principles of the housing with a three dimensional pattern coating. Moreover, in the drawing like reference numerals designate corresponding parts throughout the several views.

FIG. 1 is a cross-sectional view of a present embodiment of a housing with a three dimensional pattern coating.

FIG. 2 is a flow chart of a present embodiment of a method for making the housing shown in FIG. 1.

### DETAILED DESCRIPTION

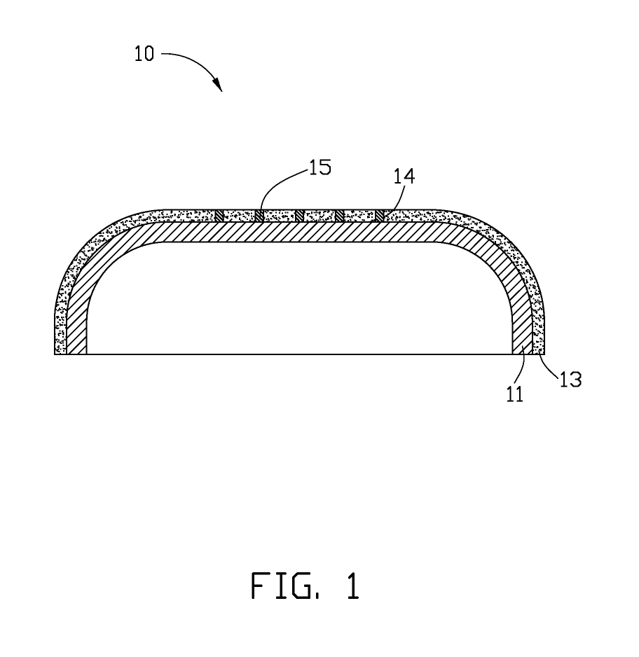

Referring to FIG. 1, in a present exemplary embodiment, a housing 10 includes a substrate 11, a powder coated layer 13 formed on one surface of the substrate 11, and a pattern coating 15 formed in the powder coated layer 13.

The substrate 11 is made of metal selected from a group consisting of aluminum, aluminum alloy, magnesium, magnesium alloy, titanium, and titanium alloy.

The powder coated layer 13 is formed on one surface of the substrate 11 by electrostatic powder coating with solid powder paint. The solid powder paint may be polyurethane resin or epoxy resin. The thickness of the powder coated layer 13 is about 60-90 μm. Some grooves 14 are formed in the powder coated layer 13 by laser etching. The grooves 14 define a desired logo or a decorative pattern of electronic devices. The depth of the grooves 14 can either be equal to or less than the thickness of the powder coated layer 13.

The pattern coating 15 is formed by filling colloidal solution into the grooves 14. The colloidal solution contains acrylic acid resin, a leveling agent, a solidifying agent, and an organic solvent. The organic solvent may be benzene, toluene, or xylene. The colloidal solution may further contain pigment. The colloidal solution possesses good leveling characteristic, and can be uniformly filled into the grooves 14. The colloidal solution filled in the grooves 14 can be solidified in an oven. As such, the pattern coating 15 is obtained. The pattern coating 15 presents three dimensional appearance. The thickness of the pattern coating 15 may be less than the thickness of the powder coated layer 13.

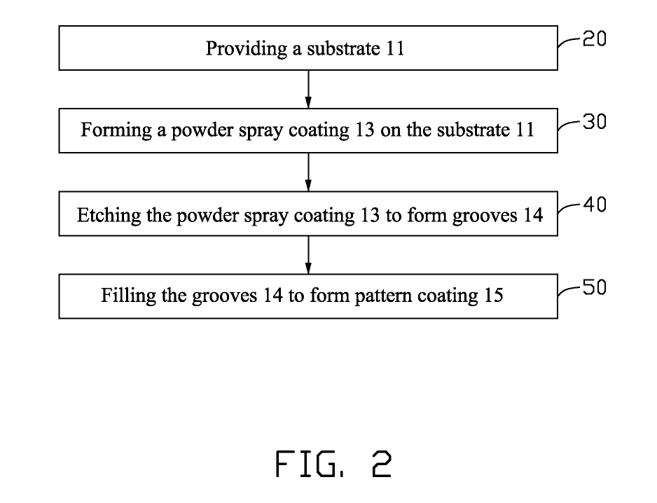

A method for making the housing 10 is provided. Referring to FIG. 2, the method comprises steps 20 to steps 50. In step 20, the substrate 11 made of metal selected from a group consisting of aluminium, aluminium alloy, magnesium, magnesium alloy, titanium, or titanium alloy is provided.

In step 30, a powder coated layer 13 is formed on one surface of the substrate 11. The method of forming powder coated layer 13 onto the substrate 11 may be electrostatic powder coating with solid powder paint. Prior to the coating step, the substrate 11 may be treated with sand blasting to roughen its surface to enhance the adhesion of the powder coated layer 13 to the substrate 11. The solid powder paint used in forming powder coated layer 13 may be polyurethane resin or epoxy resin. The thickness of the powder coated layer 13 is about 60-90 μm.

In step 40, plural grooves 14 are formed in the powder coated layer 13 by etching. The etching step is carried out by using a laser beam to shoot to the powder coated layer 13 in a designed pattern. As such, the grooves 14 are obtained. The depth of the grooves 14 may be equal to the thickness of the powder coated layer 13.

In step 50, pattern coating 15 is formed by filling the grooves 14 with colloidal solution. The colloidal solution may be acrylic acid resin colloidal solution. The colloidal solution may further comprise leveling agent, solidify agent, and organic solvent. The organic solvent may be benzene, toluene, and xylene. The colloidal solution can also contain pigment. Filling the grooves 14 may be carried out by using an injector injecting the colloidal solution into the grooves 14. The colloidal solution is at a low viscidity, it can be uniformly filled in the grooves 14. After the grooves 14 are filled, the housing 10 is baked in an oven at about 200° C. to solidify the colloidal solution. As such, the pattern coating 15 is obtained. The surface of the pattern coating 15 may be on the same plane with the surface of the powder coated layer 13.

It should be understood, the depth of the grooves 14 formed on the powder coated layer 13 can also be less than the thickness of the powder coated layer 13.

It should be understood, the surface of the pattern coating 15 can also be at a lower elevation than the surface of the powder coated layer 13.

The housing 10 prepared via the above method has a three dimensional pattern coating 15. The pattern coating 15 would not be easily abraded because its surface is either on the same plane with or lower than the surface of the powder coated layer 13. The method of making the housing 10 utilizes laser beam to etch the powder spay coating 13 to form grooves 14, which has a higher efficiency at recomposing the grooves 14 depended to the product design required.

The housing 10 disclosed in the present disclosure may be a mobile phone, a game player, or a camera. The housing 10 can also be a container or a cover of a container.

It should be understood, however, that even though numerous characteristics and advantages of the present embodiments have been set forth in the foregoing description, together with details of functions of the embodiments, the disclosure is illustrative only, and changes may be made in detail within the principles of the invention to the full extent indicated by the broad general meaning of the terms in which the appended claims are expressed.

What is claimed is:

1. A housing having a three dimensional pattern coating, comprising:
a substrate;
a powder coated layer formed on the substrate, the powder coated layer having plural grooves therein;
and a pattern coating formed in the grooves.

2. The housing as claimed in claim 1, wherein the substrate is made of metal.

3. The housing as claimed in claim 1, wherein the pattern coating is formed by filling the grooves with a colloidal solution.

4. The housing as claimed in claim 3, wherein the colloidal solution is an acrylic acid resin colloidal solution.

5. The housing as claimed in claim 1, wherein the thickness of the powder coated layer is about 60-90 μm, the solid powder paint used in the powder coated layer is polyurethane resin or epoxy resin.

6. The housing as claimed in claim 1, wherein the depth of the grooves is less than or equal to or the thickness of the powder coated layer.

7. The housing as claimed in claim 1, wherein the surface of the pattern coating is on the same plane with or lower than the surface of the powder coated layer.

8. A method for making a housing, comprising:
providing a substrate;
painting a powder coated layer onto the substrate;
etching the powder coated layer to form plural grooves;
filling the grooves with a colloidal solution.

9. The method as claimed in claim 8, wherein the substrate is made of metal.

10. The method as claimed in claim 8, wherein the painting step is carried out by electrostatic powder coating with solid powder paint, the solid powder paint is polyurethane resin or epoxy resin.

11. The method as claimed in claim 8, wherein the colloidal solution is an acrylic acid resin colloidal solution.
